(19) United States
(12) Patent Application Publication
(10) Pub. No.: US 2013/0312577 A1
(43) Pub. Date: Nov. 28, 2013

(54) FASTENER GUIDE FOR ROTARY DRIVERS

(71) Applicants: Jeffrey Burrows, Palm Harbor, FL (US); Matthew Carothers, Safety Harbor, FL (US)

(72) Inventors: Jeffrey Burrows, Palm Harbor, FL (US); Matthew Carothers, Safety Harbor, FL (US)

(73) Assignee: NEXT LEVEL TOOLS, LLC, Palm Harbor, FL (US)

(21) Appl. No.: 13/602,508

(22) Filed: Sep. 4, 2012

Related U.S. Application Data
(60) Provisional application No. 61/650,192, filed on May 22, 2012.

(51) Int. Cl. B25B 23/08; B25B 23/12

(52) U.S. Cl. 81/451

(57) ABSTRACT

Improved fastener guide devices are disclosed for installing and removing fasteners comprising a moveable cover configured to guide the fastener during operation. Devices in accordance with the disclosure further comprise a magnetic element configured to stabilize the position of the cover. In an aspect, the magnetic element stabilizes the position of the cover, retains a fastener driver, and retains a fastener engaged with the fastener guide device. In another aspect, the fastener guide device is configured to manipulate oversized screws, such as a cement board screw.

### CROSS-REFERENCE TO RELATED APPLICATIONS

This application claims the benefit of U.S. Provisional Patent Application No. 61/650,192, filed May 22, 2012, and entitled “Oversized sleeve screw holder and driver,” the entire contents of which are incorporated herein by reference.

### FIELD OF THE DISCLOSURE

The present disclosure relates to hand tools and more particularly to guiding fasteners.

### BACKGROUND

Screw holding and driving devices, also known as fastener guide devices, are well known. Screw holding and driving devices are designed to stabilize a screw or other fastener as it is being driven into a surface. These devices prevent slippage and wobble of the screw as it is being drilled into the surface.

Some screw holding and driving devices comprise a movable cover designed to be placed in an extended position over the screw as the screw is engaged by a bit and driven into a surface. Such covers are often metal or plastic sleeves which are configured to freely rotate relative to the screw bit. The user holds the cover in place over the screw as it is driven into a surface. As the screw is driven into the surface, the cover is pushed back to a retracted position. If the user does not hold the cover in position as the screw is driven into the surface, the cover may slide into a retracted position, where the screw is prematurely exposed and unstabilized by the device. In many environments, especially tight environments, it may be undesirable or impossible for the user to physically hold the cover in place as the fastener is driven into a surface. In addition, the close proximity of the user's hand to the fastener being driven into a surface poses an increased risk of injury.

Cover-based screw holding and driving devices cannot stabilize fasteners with heads larger than the diameter of the cover. Many cover-based screw holding and driving devices cannot accommodate oversized fasteners such as cement board screws, cabinet screws, lag bolts, and the like. Many of these oversized screws are used to install surfaces such as cement board. Cement board is installed mainly around bath tubs and showers where there exists a possibility of not only injuring the user, but damaging the tub itself.

Given the foregoing, there is a need for fastener guide devices which stabilize and cover the fastener as it is being driven into a surface without the user holding the cover in place and for fastener guide devices which can accommodate oversized fasteners.

### SUMMARY

This Summary is provided to introduce a selection of concepts in a simplified form that are further described below in the Detailed Description. This Summary is not intended to identify key features or essential features of the subject matter to be claimed, nor is it intended to be used to limit the scope of the subject matter to be claimed.

This disclosure addresses the above-described needs by providing devices for installing and removing fasteners comprising a moveable cover configured to guide the fastener during operation. Fastener guide devices in accordance with this disclosure further comprise a magnetic element configured to stabilize the position of the cover without assistance from the user during operation. In some aspects, the magnetic element is further configured to retain a fastener driver (e.g., bit, socket, clamp, etc.) and a fastener. The cover may be configured to accommodate oversized fasteners, such as cement board screws.

In an aspect, a fastener guide device comprises a sleeve cover, a guide, and a magnet. The sleeve cover is movable between a retracted position and an extended position and configured to accommodate oversized fasteners such as cement board screws, cabinet screws, lag bolts, and the like. The sleeve cover is slidably and rotably connected to the guide.

The guide comprises a first portion and a second portion. The guide first portion is configured to physically contact with and to transfer rotary force to a fastener but may also comprise a permanent or removal bit (e.g., a Phillips® head (available from Phillips Screw Company of Burlington, Mass.), slot head, Frearson head, Robertson® head (available from Robertson, Inc. of Ontario, Canada), etc.). The guide second portion is configured to receive rotary force from a rotary driver such as a hand drill, a screwdriver, a hand wrench, an impact wrench, an impulse driver, a pneumatic driver, or the like.

The magnet is positioned relative to the guide and configured to temporarily hold the cover in a position via magnetic forces. Cover positions include a retracted position, an extended position, and various positions between the retracted position and the extended position. The magnet holds the cover in position over a fastener being driven into a surface without the user holding the cover in place.

In another aspect of the present disclosure, the cover is configured to rotate independently of the fastener as rotary force is being applied to the fastener. Magnetic forces from the magnet resist movement of the cover along the long axis of the fastener guide device, but may be overcome by physically moving the cover. A fastener guide device with its cover in an extended position may be placed against the surface a user wishes to install the fastener in. Via the fastener guider device, the fastener may be rotated and driven into the surface. Magnetic forces will resist movement of the cover along the long axis of the fastener guide device as the fastener is driven into the surface, but physical contact with the surface will smoothly push the cover into a retracted position as the fastener is installed. This installation process ensures that the fastener is stabilized over the entire installation operation and will not slip off the guide, creating a danger to the user and to surrounding property.

Further features and advantages of the devices and systems disclosed herein, as well as the structure and operation of various aspects of the present disclosure, are described in detail below with reference to the accompanying figures.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is an exploded perspective view of a fastener guide device, in accordance with an aspect of the present disclosure.

FIGS. 2A and 2B are side views of a fastener guide device, illustrating possible positions of the cover, in accordance with various aspects of the present disclosure.

FIG. 3 is a cutaway side view of a fastener guide device engaging a fastener, in accordance with an aspect of the present disclosure.

FIG. 4 is a side view of a fastener guide device engaging a fastener, in accordance with an aspect of the present disclosure.

FIG. 5 is a cutaway side view of an alternate aspect of a fastener guide device, in accordance with an aspect of the present disclosure.

FIG. 6 is an exploded perspective view of another aspect of a fastener guide device wherein the fastener driver is removable, in accordance with an aspect of the present disclosure.

FIG. 7 is a cutaway side view of a fastener driver device, in accordance with an aspect of the present disclosure.

FIG. 8 is a cutaway side view of a shank portion of a fastener driver device, in accordance with an aspect of the present disclosure.

FIG. 9 is a cutaway side view of another aspect of a fastener guide device wherein the shank further comprises a magnet and the fastener driver is removable, in accordance with an aspect of the present disclosure.

FIG. 10 is a perspective view of a fastener guider device engaged with a rotary driver, in accordance with an aspect of the present disclosure.

### DETAILED DESCRIPTION

The present disclosure is directed to devices for installing and removing fasteners comprising a moveable cover configured to guide the fastener during operation. Devices in accordance with this disclosure further comprise a magnetic element configured to stabilize the position of the cover.

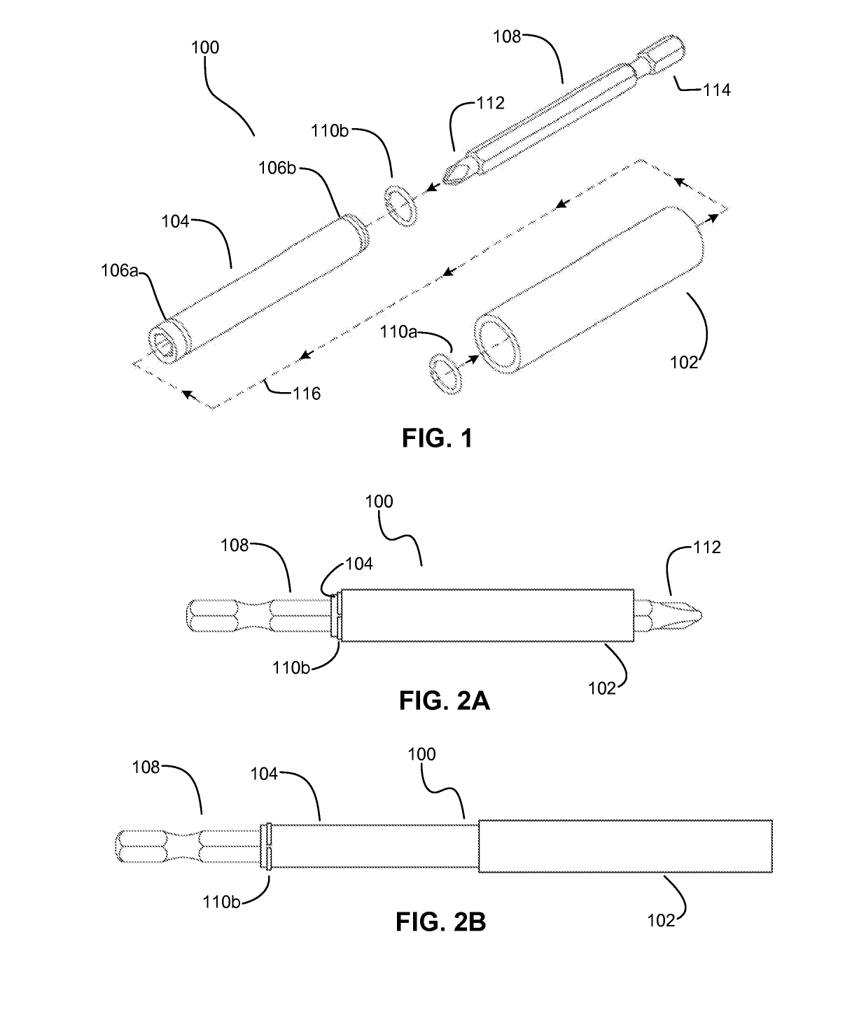

Referring to FIG. 1, an exploded perspective view of a fastener guide device 100, in accordance with an aspect of the present disclosure, is shown.

Fastener guide device 100 comprises a cover 102, a guide 104, and a magnet (not shown in FIG. 1). Fastener guide device 100 is configured to position, install, or remove a fastener. Fastener guide device 100 is assembled in the manner indicated by assembly line 116. Portions of fastener guide device 100 are assembled along a longitudinal axis in the manner indicated by assembly line arrows.

Cover 102 is a mechanism, such as a sleeve, configured for guiding and retaining a fastener (not shown in FIG. 1) when fastener guide device 100 is in operation. Cover 102 comprises a first portion and a second portion. The first portion has an inner cross section. Cover 102 is configured to receive a fastener (not shown in FIG. 1) with a maximum cross section less than or equal to the inner cross section of the first portion. The inner cross section may be a circle with a diameter of 12.3 mm, approximately the diameter of the head of an oversized cabinet screw (approximately 12.1 mm). The inner cross section may be square, rectangle, hexagon, or any other shape apparent to one having ordinary skill in the relevant arts after reading the present disclosure.

The length of the first portion is chosen to at least partially enclose a fastener when faster guide device 100 is in use. When configured for use with oversized fasteners such as cement board screws, cabinet screws, lag bolts, and the like, the first portion may be 42 mm in length. In some aspects, the first portion length is chosen to enclose an entire fastener when in use. In alternative aspects, the first portion length is chosen to enclose the majority of a fastener along the fastener's length with fastener guide device 100 is in use, but exposing the tip of the fastener, in order to facilitate positioning of the fastener for installation.

As shown in FIG. 1, cover 102 may be configured to encircle fastener along the length of the first portion. In another aspect, cover 102 partially encloses fastener along the length of the first portion. The first portion further comprises one or more openings configured to allow the user to view the interior of the first portion. Openings allow the user to visually inspect a fastener being manipulated by fastener guide device 100 in order to ensure that the fastener remains engaged with fastener guide device 100. Openings may also be configured to provide pathways for debris to escape the interior of cover 102 during fastener guide device 100 operation.

Cover 102 slidably connects to guide 104 at the second portion. The second portion comprises an inner cross section and a length. The second portion inner cross section may be of a different configuration than the first portion inner cross section.

In an aspect, the inner cross section of the second portion is approximately equal to the guide outer profile. The length of the second portion is chosen to reduce cover 102 wobble. The length of the cover second portion may be one quarter the length of the first portion.

Guide 104 is configured to transfer rotary force to a fastener. Guide 104 is a rigid member comprising a first portion, a body, and a second portion. Guide 104 has an outer profile and an inner cross section. The guide outer profile is a circle. The diameter is uniform along the length of guide 104.

In an alternate aspect, the guide outer profile is non-circular. In another aspect, the guide outer profile is circular wherein the diameter varies over the length of cover 104.

The guide first portion further comprises channel 106a. Retainer 110a is a split ring configured to attach to guide 104 at channel 106a. Collectively, channel 106a and retainer 110a form a physical stop at the guide first portion.

The guide second portion further comprises channel 106b. Retainer 110b is a split ring configured to attach to guide 104 at channel 106b. Collectively, channel 106b and retainer 110b form a physical stop at the guide second portion.

In an alternate aspect, physical stops are formed by varying the outer profile of guide 104. The outer profile at the first portion and the second portion are greater than the outer profile at the body, forming physical stops.

Guide 104 further comprises shank 108. Shank 108 is a rigid member configured to transfer rotary force to fastener guide device 100 comprising a first portion 112, a body, and a second portion 114. Shank 108 may be solid. Shank 108 has an outer profile. The outer profile may be a regular hexagon wherein the outer profile is uniform along the length of the body of shank 108.

In an alternate aspect, the outer profile is not hexagonal. The outer profile may be chosen to interface with guide 104 and transfer rotary force without slippage.

Shank second portion 114 is configured to removably connect to a rotary driver such as a hand drill, a screwdriver, a hand wrench, an impact wrench, an impulse driver, a pneumatic driver, or the like

Shank first portion 112 is configured to physically interface with a fastener such that rotary force may be transferred. Shank first portion 112 may be a screw bit (e.g., a Phillips® head (available from Phillips Screw Company of Burlington, Mass.), slot head, Frearson head, Robertson® head (available from Robertson, Inc. of Ontario, Canada), etc.), a socket, a clamp, or the like. In some aspects, shank first portion 112 is removable or reconfigurable.

In an alternate aspect, shank first portion 112 is not configured to directly interface with a fastener. Shank 108 may be configured to connect with guide 104 and transfer rotary force to guide 104. Guide 104 may be configured to physically interface with a fastener. The first portion of guide 104 may be configured as a screw bit, a socket, a clamp, or the like.

In another aspect, shank 108 is omitted. The first portion of guide 104 is configured to physically interface with and transfer rotary force to a fastener. The second portion of guide 104 is configured to receive rotary force from a user, a hand drill, a screwdriver, a hand wrench, an impact wrench, an impulse driver, a pneumatic driver, or the like.

Guide 104 is configured to transfer rotary force to a fastener when the fastener is in physical contact with fastener guide device 100. In the aspect depicted in FIG. 1, rotary force is transferred to a fastener via shank 108 with a hexagonal outer profile. The inner cross section of guide 104 is configured to slidably attach to shank 108. The inner cross section of guide 104 may be a regular hexagon with dimensions approximately equal to the outer profile of shank 108.

Guide 104 may permanently attach to shank 108. In another aspect, guide may be removably attached to shank 108 or another rigid member with an outer profile which permits interfacing with guide 104.

Fastener guide device 100 further comprises a magnet (not shown in FIG. 1). The magnet is positioned relative to guide 104 and is configured to temporarily hold cover 102 in a position relative to guide 104 via magnetic forces. The magnet may be fixed in a static position relative to guide 104 or may move relative to guide 104.

The magnet is configured to temporarily hold cover 102 in a first retracted position, a second extended position, and various positions between the retracted position and the extended position.

The magnet may be contained within the interior of shank 108. In some aspects, the magnet is contained within the body of shank 108. In another aspect, the magnet is located at the first portion of shank 108. In an alternative aspect, shank 108 is constructed of magnetic materials.

In another aspect, guide 104 may further comprise the magnet at the first portion of guide 104, the guide body, or the second portion of guide 104. In an alternate aspect, guide 104 is constructed of magnetic materials.

In yet another aspect, cover 102 may further comprise the magnet at the first portion or the second portion. In an alternative aspect, cover 102 is constructed of magnetic materials.

Referring now to FIGS. 2A and 2B, side views of fastener guide device 100 illustrating possible positions of cover 102, in accordance with various aspects of the present disclosure, are shown.

Fastener guide device 100 is configured such that cover 102 is movable between a first position and a second position. The first position may be a retracted position. The second position may be an extended position. In an extended position, cover 102 partially encloses a fastener. When in the extended or a partially extended position, cover 102 guides and retains a fastener engaged by fastener guide device 100.

The outer profile of guide 104 is chosen to allow cover 102 to slidably connect to guide 104 at the guide body and move along the guide body from a retracted position to an extended position. The retracted position is depicted in FIG. 2A. The retracted position is defined by the physical stop at the second portion of guide 104. The physical stop defining the retracted position is formed collectively by channel 106b and retainer 110b. The physical stop prevents the second portion of cover 102 from sliding beyond the physical stop at the guide second portion.

The extended position is shown in FIG. 2B. The extended position is defined by the physical stop at the first portion of guide 104. The physical stop defining the extended position is formed collectively by channel 106a and retainer 110a (not shown in FIGS. 2A and 2B). The physical stop prevents the second portion from sliding beyond the physical stop at the guide first portion.

In an alternative aspect, guide 104 does not comprise physical stops. Movement of cover 102 is limited by magnetic forces from the magnet positioned relative to guide 104. Where magnetic forces limit the movement of cover 102 and guide 104 is comprised of at least one magnet, cover 102 is at least partially constructed of a ferromagnetic material (e.g., iron, steel, nickel, etc.). In another aspect where cover 102 comprises a magnet, guide 104 is at least partially constructed of a ferromagnetic material.

In some aspects, cover 102 is configured to rotatably and slidably connect to guide 104. The outer profile of the guide body may be a uniform circle. The inner cross section of the second portion of cover 102 may be approximately equal to the outer profile of the guide body. The inner cross section and the length of the cover second portion may form a cylinder which slidably and rotatably connects with guide 104 at the guide body.

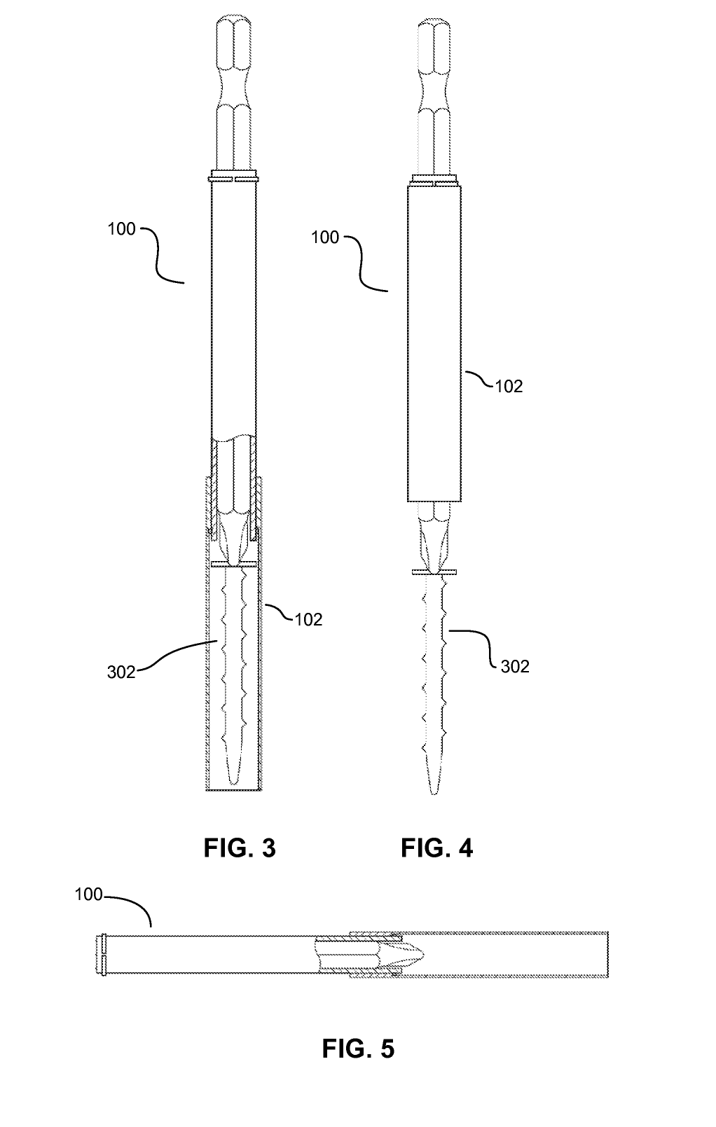

Referring now to FIG. 3, a cutaway side view of fastener guide device 100 engaging a fastener, in accordance with an aspect of the present disclosure, is shown wherein cover 102 is in the extended position.

Cover 102 may be configured to enclose fastener 302 along the length of fastener 302 when fastener 302 is engaged by fastener guide device 100 and cover 102 is in the extended position. The inner cross section of cover 102 may be approximately equal to the head portion of fastener 302.

Referring now to FIG. 4, a side view of fastener guide device 100 engaging fastener 302, in accordance with an aspect of the present disclosure, is shown wherein cover 102 is in the retracted position. The first portion of guide 104, further comprises the first portion of shank 108 and may be exposed when cover 102 is in the retracted position, facilitating engagement of fastener 302.

Referring now to FIG. 5, a cutaway side view of an alternative aspect of fastener guide device 100, in accordance with an aspect of the present disclosure, is shown. That is, FIG. 5 depicts a fastener guide device 100 wherein the second portion of shank 108 is not configured to interface with a hexagonal socket of a rotary driver as shown in FIGS. 1 through 4. Rather, shank 108 is positioned within guide 104 and has a length substantially shorter than the length of guide 104. A cavity is formed within guide 104, configured to interface with a rotary driver at the second portion of guide 104. A rigid member attached to a rotary driver may be inserted into guide 104 at the second portion of guide 104 and transfer rotary force.

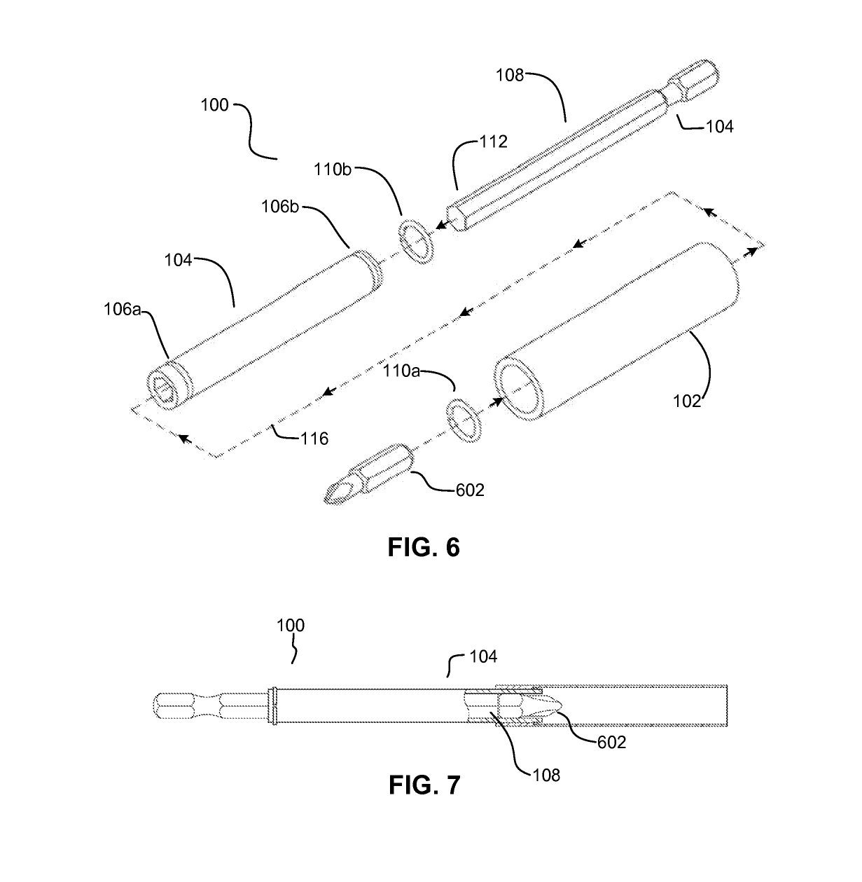

Referring now to FIG. 6, an exploded perspective view of another aspect of fastener guide device 100 utilizing a removable fastener driver 502, in accordance with an aspect of the present disclosure, is shown.

In another aspect, fastener driver device 100 comprises cover 102, guide 104, and shank 108. Shank 108 is partially inserted into guide 104 such that a cavity is formed at the first portion of guide 104. The cavity is configured to receive removable driver 602. Removable driver 602 may be a screwdriver bit such as a Phillips® head (available from Phillips Screw Company of Burlington, Mass.), slot head, Frearson head, Robertson® head (available from Robertson, Inc. of Ontario, Canada), and the like. Removable driver 602 may be a socket attachment, clamp attachment, or other device configured to engage fastener 302.

Referring now to FIG. 7, a cutaway side view of fastener driver device 100, in accordance with an aspect of the present disclosure, is shown. As described with reference to FIG. 6, shank 108 may be partially inserted into guide 104. FIG. 7 depicts the cavity formed at the first portion of guide 104 by partially inserting shank 108 into guide 104. Fastener driver 502 may be removably inserted into the cavity formed at the first portion of guide 104, where it may engage fastener 302 and transfer rotary force to fastener 302.

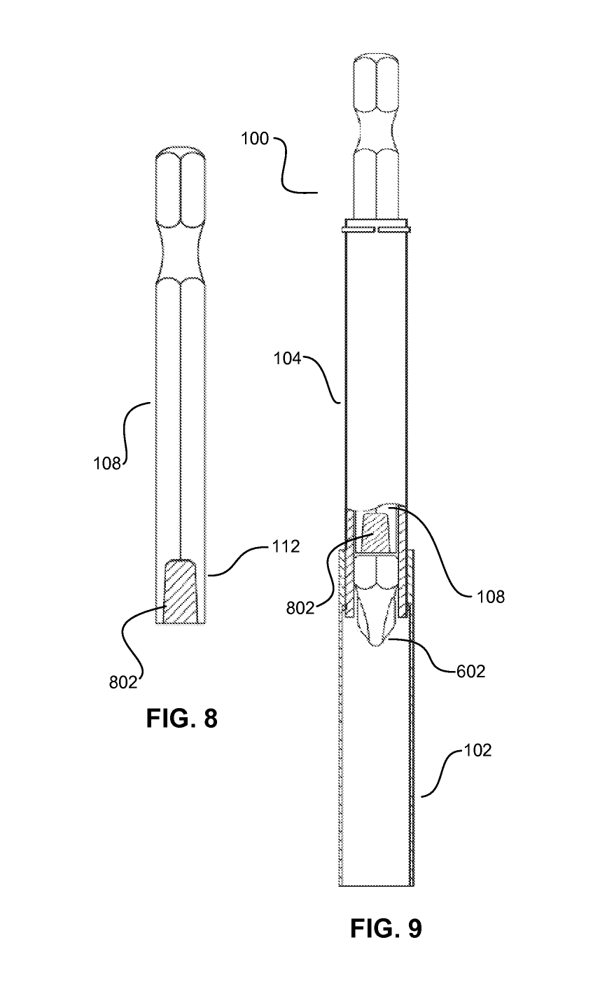

Referring briefly now to FIG. 8, a cutaway side view of shank 108, in accordance with an aspect of the present disclosure, is shown. In an aspect, first portion 112 comprises a cavity. The magnet is magnetic insert 802. Magnetic insert 802 is placed in the cavity and attached to shank 108.

Referring now to FIG. 9, a cutaway side view of another aspect of fastener guide device 100 wherein shank 108 further comprises magnetic insert 802, in accordance with an aspect of the present disclosure, is shown. That is, in such an aspect, fastener guide device 100 comprises cover 102, guide 104, shank 108, and magnetic insert 802. Shank 108 is positioned within guide 104 to form a cavity at the first portion of guide 104, configured to receive removable driver 602. Magnetic insert 802 is configured to retain removable driver 602 and stabilize the position of cover 102 when cover 102 is in the extended position, as shown, a partially extended position, or the retracted position. Magnetic insert 802 may also retain fastener 302 via magnetic forces when fastener 302 is engaged with fastener guide device 100.

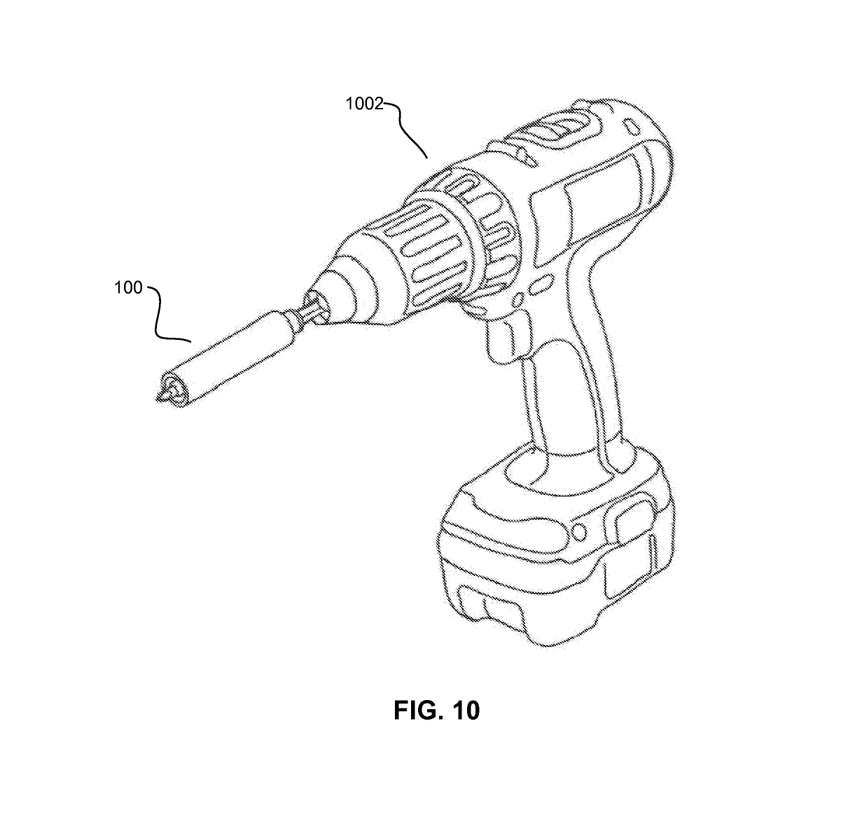

Referring now to FIG. 10 a perspective view of fastener guide device 100 in use, in accordance with an aspect of the present disclosure, is shown. Fastener guide device 100 is connected to hand drill 1002 at shank second portion.

While various aspects of the present disclosure have been described above, it should be understood that they have been presented by way of example and not limitation. It will be apparent to persons skilled in the relevant art(s) that various changes in form and detail can be made without departing from the spirit and scope of the present disclosure. The present disclosure should not be limited by any of the above described aspects, but should be defined only in accordance with the following claims and their equivalents.

In addition, it should be understood that the figures, which highlight the structure, methodology, functionality and advantages of the present disclosure, are presented as examples only. The present disclosure is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A fastener guide device comprising:
a cover moveable between a first position and a second position and configured to partially enclose a fastener;
a guide slidably connected to the cover comprising a first portion and a second portion, wherein the guide first portion is configured to transfer rotary force to the fastener, and;
a magnet positioned relative to the guide, wherein the magnet is configured to temporarily hold the cover in a position relative to the guide.

2. The fastener guide device of claim 1, wherein the guide is a sleeve.

3. The fastener guide device of claim 1, wherein the magnet is statically positioned within the guide.

4. The fastener guide device of claim 1, wherein magnet is configured to temporarily hold the fastener in a position relative to the guide.

5. The fastener guide device of claim 1, further comprising:
a shank having a first portion and a second portion, wherein the shank is rigidly attached to the guide second portion and the shank is configured to transfer rotary force to the guide.

6. The fastener guide device of claim 5, wherein the magnet is a portion of the shank first portion.

7. The fastener guide device of claim 1, wherein the guide is a sleeve having an external diameter and a uniform internal cross section, and further comprising:
a shank with an outer profile approximately equal to the guide internal cross section and having a first portion and a second portion, wherein the first portion of the shank is positioned within the second portion of the guide such that a cavity is formed at the first portion of the guide, the cavity configured to receive a fastener driver.

8. The fastener guide device of claim 7, wherein the internal cross section of the guide is a hexagonal cross section.

9. The fastener guide device of claim 7, wherein the magnet is statically positioned within the first portion of the shank, and configured to retain the fastener driver via magnetic force.

10. The fastener guide device of claim 1, wherein the cover is configured to rotatably slide along the guide from the first position to the second position.

11. The fastener guide device of claim 1, wherein the cover is a cylinder with a first portion and a second portion and configured to partially enclose a fastener, further comprising:
an outer diameter;
a first portion inner diameter, wherein the first portion inner diameter is less than the outer diameter and first portion inner diameter is greater than the cross sectional width of a fastener the fastener guide device is configured to manipulate;
a second portion inner diameter, wherein the second portion inner diameter is less than the first portion inner diameter and is approximately equal to the diameter of the slidably connected guide portion;
a first portion length, wherein the first portion may at least partially enclose a fastener the faster guide device is configured to manipulate, and;
a second portion length.

12. The fastener guide device of claim 11, wherein the fastener is an oversized fastener.

13. The fastener guide device of claim 1, wherein the guide comprises:
a first retainer positioned on the first guide portion, and
a second retainer positioned on the second guide portion;
wherein the first retainer and the second retainer are configured to limit the movement of the cover to the first position, the second position, and a plurality of positions between the first position and the second position.

14. The fastener guide device of claim 1, wherein the guide is connected at the second end portion to a rotary driver chosen from the group consisting of a drill, a screwdriver, a hand wrench, an impact wrench, an impulse driver, and a pneumatic driver.

15. The fastener guide device of claim 1, further comprising:
a fastener driver chosen from the group consisting of a bit, a socket, and a clamp.

16. A fastener guide device comprising:
a cylindrical cover moveable between a first position and a second position, configured to partially enclose a fastener;
a cylindrical sleeve guide with an outer profile and an inner hexagonal cross section, configured to rotatably and slidably connect to the cover, the guide comprising a first portion further comprising an annular channel and a second portion further comprising an annular channel, wherein the guide is configured at the first portion to transfer rotary force to a fastener and the second portion is configured to receive rotary force;
a shank having a first portion further comprising a magnet, and a second portion, the shank having an outer profile approximately equal to the guide internal cross section, wherein the first portion of the shank is positioned within the second portion of the guide such that a cavity is formed at the first portion of the guide, configured to receive a fastener driver and the magnet is configured to temporarily hold the cover in a position relative to the guide, to retain the fastener driver, and to retain the fastener;
a first retainer positioned in the annular channel of the first portion of the guide and configured to limit the movement of the cover, and
a second retainer positioned in the annular channel of the second portion of the guide and configured to limit the movement of the cover.

17. The fastener guide device of claim 16, wherein the cover is a cylinder with a first portion and a second portion, configured to partially enclose a fastener, further comprising:
an outer diameter;
a first portion inner diameter, wherein the inner diameter of the first portion is less than the outer diameter and is greater than the cross sectional width of the fastener the fastener guide device is configured to manipulate;
a second portion inner diameter, wherein the inner diameter of the second portion is less than the inner diameter of the first portion and is approximately equal to the diameter of the slidably connected guide portion;
a first portion length, wherein the first portion is configured to at least partially enclose a fastener the faster guide device is configured to manipulate, and;
a second portion length.

18. A fastener guide device comprising:
a cylindrical cover moveable between a first position and a second position and configured to partially enclose a fastener, the cover further comprising an outer diameter, a first portion inner diameter wherein the inner diameter of the first portion is less than the outer diameter and is greater than the cross sectional width of a fastener the fastener guide device is configured to manipulate, a second portion inner diameter wherein the inner diameter of the second portion is less than the inner diameter of the first portion and is approximately equal to the diameter of the slidably connected guide portion, a first portion length wherein the cover is configured to at least partially encloses the fastener the faster guide device is configured to manipulate, and a second portion length;
a cylindrical sleeve guide with an outer profile and an inner hexagonal cross section, configured to rotatably and slidably connect to the cover comprising a first portion further comprising an annular channel and a second portion further comprising an annular channel, wherein the guide is configured at the first portion to transfer rotary force to a fastener and the second portion is configured to receive rotary force;
a shank having a first portion further comprising a magnet and a second portion, the shank having an outer profile equal to the internal cross section of the guide, wherein the shank first portion is positioned within the second portion of the guide such that a cavity is formed at the first portion of the guide, configured to receive a fastener driver and the magnet is configured to temporarily hold the cover in a position relative to the guide and to retain the fastener driver;
a rotary driver connected to shank second portion for transfer of rotary force to the shank;
a first split ring retainer positioned in the annular channel of the first portion of the guide, configured to limit the movement of the cover, and;
a second split ring retainer positioned in the annular channel of the second portion of the guide, configured to limit the movement of the cover.
